(19) United States
(12) Patent Application Publication
(10) Pub. No.: US 2017/0022916 A1
(43) Pub. Date: Jan. 26, 2017

(54) CONTROLLER AND CONTROL METHOD FOR POWER CONVERTER

(71) Applicant: TOYOTA JIDOSHA KABUSHIKI KAISHA, Toyota-shi, Aichi-ken (JP)

(72) Inventors: Makoto HIRAI, Suntou-gun, Shizuoka-ken (JP); Toru ANDO, Obu-shi, Aichi-ken (JP)

(73) Assignee: TOYOTA JIDOSHA KABUSHIKI KAISHA, Toyota-shi, Aichi-ken (JP)

(21) Appl. No.: 15/039,581

(22) PCT Filed: Nov. 26, 2014
(86) PCT No.: PCT/IB2014/002563

§ 371 Date: May 26, 2016

(30) Foreign Application Priority Data
Nov. 29, 2013 (JP) 2013-248650

(51) Int. Cl. F02D 41/02; B60W 10/30; F01N 3/20; B60W 20/20; B60L 11/18; B60K 6/442; B60W 10/26

(52) U.S. Cl. CPC F02D 41/024; B60K 6/442; B60W 10/30; B60W 10/26; B60W 20/20; B60L 11/1855; B60L 11/1868; F01N 3/2006; B60L 11/1803; B60Y 2300/474; B60W 2530/12; B60L 11/005

(57) ABSTRACT

In a controller and a control method for a power converter of a vehicle, the power converter has a first operation mode and a second operation mode defining power supply modes of first and second DC power supplies with respect to a load. The first operation mode is an operation mode set when the first and second DC power supplies are electrically connected in series to an electric wire electrically connected to the load. The second operation mode is an operation mode set when the first and second DC power supplies are electrically connected in parallel to the electric wire. The controller includes an electronic control unit. The electronic control unit is configured to execute warm-up promotion control of a catalytic device. The electronic control unit is configured to set the operation mode of the power converter to the second operation mode when executing the warm-up promotion control.

### BACKGROUND OF THE INVENTION

1. Field of the Invention

The present invention relates to a technical field of a controller and a control method for a power converter.

2. Description of Related Art

As a power converter that is applicable to a vehicle including a plurality of direct current (DC) power supplies, the power converter has been available that can switch among relations of electrical connections between the plurality of DC power supplies and a load (see Japanese Patent Application Publication No. 2012-070514 (JP 2012-070514 A)). As operation modes for defining these relations of electrical connections, JP 2012-070514 A discloses a series mode in which the plurality of DC power supplies and the load are electrically connected in series and a parallel mode in which these are electrically connected in parallel.

In addition, a configuration that includes a mode in which the two DC power supplies are connected in parallel to supply power to the load is also disclosed in Japanese Patent Application Publication No. 2000-295715 (JP 2000-295715 A). However, a device described in JP 2000-295715 A cannot perform voltage conversion processing on both of the two DC power supplies.

Furthermore, Japanese Patent Application Publication No. 2008-054477 (JP 2008-054477 A) discloses a configuration that includes a mode in which a power supply voltage of each of the two DC power sources is lowered to supply power to the load.

JP 2012-070514 A discloses that the series mode excels at efficiency and usability of stored energy and that the parallel mode excels at responsiveness to load power and a power management property. However, clear switching conditions for these in view of characteristics of the each operation mode are not disclosed at all. These switching conditions are not disclosed in other patent literature, either.

Here, there is a tendency in recent years that the efficiency is emphasized for hybrid vehicles from the perspective of efficient use of power resources. Accordingly, when any of these types of power converters is applied to a hybrid vehicle, it is estimated that the series mode, which is superior to the parallel mode in terms of the efficiency, is more likely to be selected than the parallel mode.

By the way, in the series mode, an output current of the power converter is restricted to an output current of the DC power supply whose maximum output current value is the smallest of the plurality of DC power supplies. Thus, during a travel as an electric vehicle (EV) in which request output of a drive axle coupled to drive wheels is completely generated by a motor, if the power converter is operated in the series mode simply from the perspective of the efficiency, actuation of an internal combustion engine tends to be required to offset a shortage of the output. In other words, a switching request from an EV travel to a hybrid vehicle (HV) travel tends to be made.

Meanwhile, exhaust purification performance of a catalytic device that is provided in the internal combustion engine is low when the catalytic device is not sufficiently warmed. Thus, when warming of the catalytic device has not been completed, control for promoting warming of the catalytic device, such as retardation control of ignition timing, tends to be executed.

Here, especially when the HV travel is requested during execution of the control for warming the catalytic device, the power has to be supplied from the internal combustion engine to the drive axle in a state that the exhaust purification performance of the catalytic device is not ensured. In this case, there is a possibility that exhaust emissions of a vehicle deteriorate. In a conventional device in which a clear suggestion is not made on how to control the operation modes of the power converter in accordance with a driving condition of the vehicle, it may be impossible to avoid such deterioration of the emissions.

### SUMMARY OF THE INVENTION

The present invention provides a controller and a control method for a power converter that can suppress deterioration of emissions when a catalyst has not been warmed in a vehicle mounted with a power converter that can select a series mode and a parallel mode.

The controller for the power converter according to the present invention is a controller for a power converter of a vehicle. The vehicle has an internal combustion engine, a motor, a first DC power supply and a second DC power supply. The internal combustion engine includes a catalytic device. The power converter has a first operation mode and a second operation mode that define power supply modes of the first and second DC power supplies for a load. The first operation mode is an operation mode set when the first DC power supply and the second DC power supply are electrically connected in series to an electric wire. The second operation mode is an operation mode set when the first DC power supply and the second DC power supply are electrically connected in parallel to the electric wire. The electric wire is electrically connected to the load. The controller includes an electronic control unit. The electronic control unit is configured to execute warm-up promotion control of the catalytic device. The electronic control unit is configured to set the operation mode of the power converter to the second operation mode when executing the warm-up promotion control.

The controller for the power converter according to the present invention is a device for controlling the power converter that has, as the operation modes, the first operation mode (that is, a series mode) and the second operation mode (that is, a parallel mode). A physical configuration and an electrical configuration of the power converter for realizing the first operation mode and the second operation mode do not affect concept of the present invention. In other words, any physical and electrical configurations can be adopted.

According to the controller for the power converter according to the present invention, the operation mode of the power converter is controlled to the second operation mode, that is, the parallel mode when an electronic control unit executes the warm-up promotion control of the catalytic device. In the second operation mode, maximum output current of the power converter is not restricted by a state of each of the DC power supplies. In other words, maximum output of the motor that constitutes a part of the load of the power converter or the motor that is connected to the load of the power converter is higher in the parallel mode.

Thus, according to the controller for the power converter according to the present invention, in an execution period of the warm-up promotion control of the catalytic device, in other words, in a period that the catalytic device is not warm, EV travel, in which requested output of a drive shaft is covered only by output of the motor, can be continued as long as possible. An opportunity that an actuation request of the internal combustion engine to compensate for a shortage of the output is made is inevitably reduced. Thus, the warm-up promotion control of the catalytic device can be continued as long as possible. The actuation request of the internal combustion engine can also be said as a switching request to HV travel. As a result, actuation frequency of the internal combustion engine can be reduced before warming of the catalyst is completed. Thus, deterioration of emissions of the vehicle can be suppressed.

Noted that the warm-up promotion control includes control for relatively increasing an exhaust temperature of the internal combustion engine and the like, for example. For example, the catalyst warm-up control includes retardation control of ignition timing, imbalance control of an air-fuel ratio, and the like.

One aspect of the controller for the power converter according to the present invention further includes determination means for determining whether the warm-up promotion control is being executed. The mode control means may control the operation mode to the second operation mode when it is determined by the determination means that the warm-up promotion control is being executed.

According to this aspect, it is determined whether the warm-up promotion control is being executed. Thus, such a case is prevented that the second operation mode is unnecessarily selected when the warm-up promotion control is not executed.

In another aspect of the controller for the power converter according to the present invention, the mode control means may prohibit control in the first operation mode during execution of the warm-up promotion control.

According to this aspect, when the warm-up promotion control is executed, the control of the power converter in the first operation mode is prohibited. When a plurality of switching conditions for the operation mode of the power converter is present, independently of a control requirement of the electronic control unit, the operation mode may be switched to the first operation mode by another requirement. According to this aspect, the control of the power converter in the first operation mode is prohibited. Accordingly, the operation mode is either switched to the second operation mode or maintained to the second operation mode. Thus, the deterioration of the emissions of the vehicle can reliably be prevented.

In yet another aspect of the controller for the power converter according to the present invention, the mode control means may switch the operation mode in accordance with the driving condition of the vehicle when the first operation mode is selected as a previous operation mode during an execution period of the warm-up promotion control, and when a specified condition is established except for a condition related to presence or absence of the execution of the warm-up promotion control.

According to this aspect, when the warm-up promotion control is executed, and when the first operation mode is selected as the previous operation mode, the first operation mode is continued depending on another condition (a specified condition) except for the condition related to presence or absence of the execution of the warm-up promotion control.

Here, whether the second operation mode should be selected during the execution period of the warm-up promotion control is determined in accordance with a relation between the maximum output of the motor and the requested output of the drive shaft (or requested output of the vehicle). In other words, if it is determined that the shortage of the output does not occur even in the first operation mode, in which the maximum output of motor is restricted, necessity to select the second operation mode whose efficiency is inferior to the first operation mode becomes low. Here, the specified condition is a condition that is experimentally, experientially, or theoretically set in advance by being associated with such a rational reason for selecting the second operation mode.

According to this aspect, when the specified condition is satisfied, it is determined that the selection of the operation mode from a perspective of warming of the catalyst is not necessarily required. Thus, the appropriate operation mode that corresponds to the driving condition of the vehicle is selected. Therefore, the power converter can flexibly and efficiently be operated while the deterioration of the emissions is suppressed.

Meanwhile, the control method for the power converter according to the present invention is a control method for a power converter of a vehicle. The vehicle includes an internal combustion engine, a motor, a first DC power supply, a second DC power supply, the power converter and an electronic control unit. The internal combustion engine includes a catalytic device. The power converter has a first operation mode and a second operation mode for defining power supply modes of the first and second DC power supplies to a load. The first operation mode is an operation mode set when the first DC power supply and the second DC power supply are electrically connected in series to an electric wire. The second operation mode is an operation mode set when the first DC power supply and the second DC power supply are electrically connected in parallel to the electric wire. The electric wire is electrically connected to the load The control method includes executing, by the electronic control unit, warm-up promotion control of the catalytic device; and setting, by the electronic control unit, the power converter to the second operation mode when the warm-up promotion control is executed by the electronic control unit.

Thus, according to the control method for the power converter according to the present invention, in a period that the catalytic device is not warm, the warm-up promotion control of the catalytic device can be continued as long as possible. As a result, the deterioration of the emissions of the vehicle can be suppressed.

Such advantages and other effects of the present invention will become apparent from embodiments which will be described next.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration diagram for schematically showing a configuration of a hybrid vehicle according to a first embodiment of the present invention;

FIG. 2 is a cross-sectional view for schematically showing a side view of an engine in the vehicle shown in FIG. 1;

FIG. 3 is a schematic configuration diagram of a PCU in the vehicle shown in FIG. 1;

FIG. 4 is a circuit configuration diagram of a boosting system in the PCU shown in FIG. 3;

FIG. 5 is a circuit diagram of a general boosting circuit;

FIG. 6A is a pattern diagram of a current path in the parallel mode of the boosting system shown in FIG. 4;

FIG. 6B is a pattern diagram of a current path in the series mode of the boosting system shown in FIG. 4;

FIG. 7 is a flowchart of operation mode control according to the first embodiment;

FIG. 8 is a chart for illustrating a temporal transition of output in relation to an effect of the operation mode control;

FIG. 9 is a flowchart of the operation mode control according to a second embodiment of the present invention;

FIG. 10 is a flowchart of the operation mode control according to a third embodiment of the present invention; and

FIG. 11 is a schematic configuration diagram for schematically showing a configuration of a drive system in a hybrid vehicle according to a fourth embodiment of the present invention.

### DETAILED DESCRIPTION OF EMBODIMENTS

Various embodiments of the present invention will hereinafter be described with reference to the drawings.

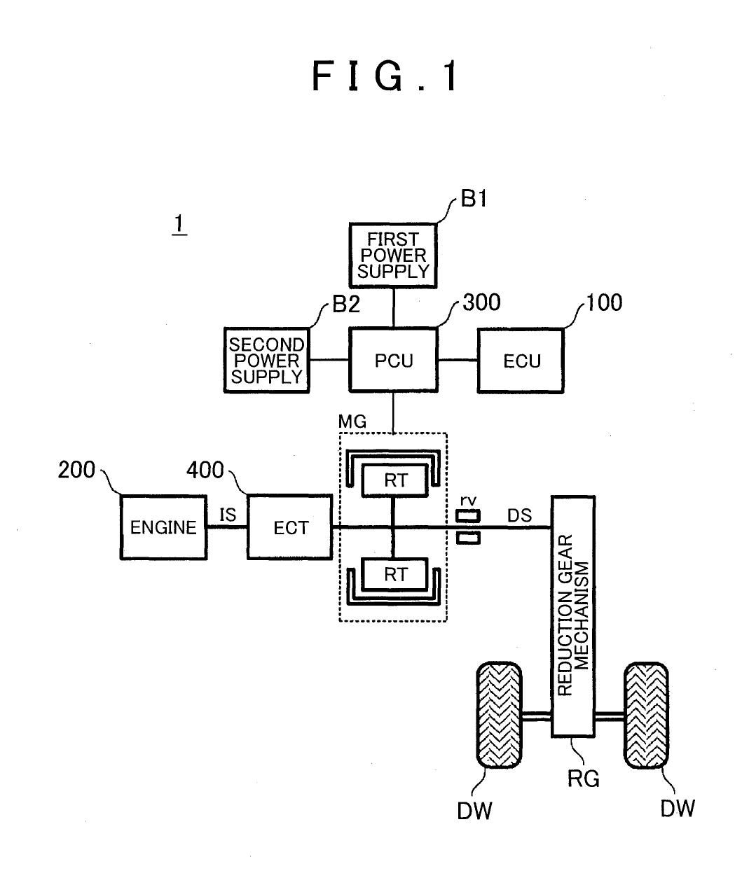

First, referring to FIG. 1, a configuration of a hybrid vehicle 1 according to a first embodiment of the present invention will be described. Here, FIG. 1 is a schematic configuration diagram for schematically showing the configuration of the hybrid vehicle 1.

In FIG. 1, the hybrid vehicle 1 is a hybrid vehicle as an example of the “vehicle” according to the present invention, and includes an electronic control unit (ECU) 100, an engine 200, a power control unit (PCU) 300, an electronic controlled transmission (ECT) 400, a motor generator MG, a reduction gear mechanism RG, a first power supply B1, and a second power supply B2.

Noted that a hybrid vehicle of so-called one motor type is illustrated in this embodiment. However, the vehicle according to the present invention may be a hybrid vehicle of two-motor type that includes two motor generators or a vehicle that includes three or more motor generators.

The ECU 100 is an electronic control unit that includes a CPU, a ROM, a RAM, and the like and that is configured to be able to control an operation of an each component of the hybrid vehicle 1. The ECU 100 is configured to be able to execute operation mode control, which will be described below, by executing a control program stored in the ROM. Noted that the ECU 100 in this embodiment is a single controller; however, the electronic control unit according to the present invention may be configured by including a plurality of the controllers.

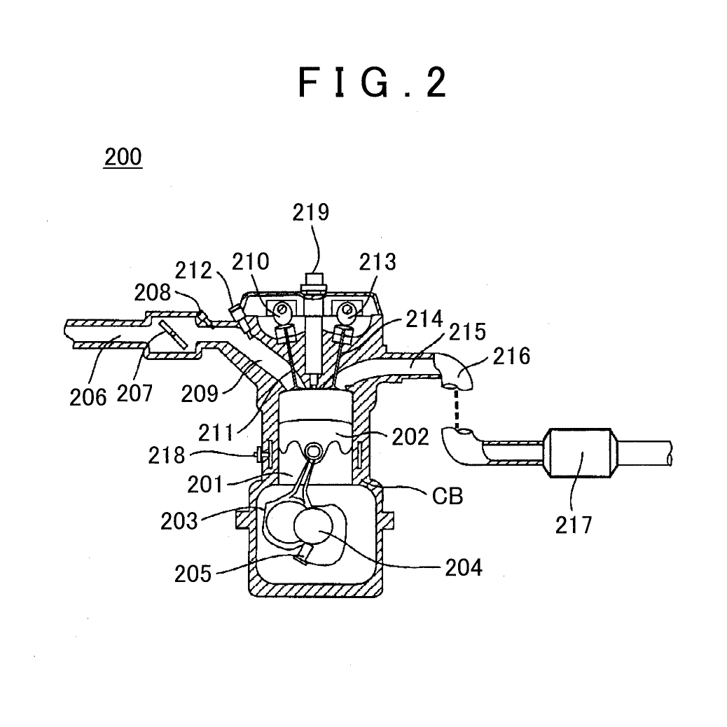

The engine 200 is a multicylinder gasoline engine as an example of the “internal combustion engine” according to the present invention. Referring to FIG. 2, a detailed configuration of the engine 200 will be described. Here, FIG. 2 is a cross-sectional view for schematically showing a side view of the engine 200.

In FIG. 2, the engine 200 includes a plurality of cylinders 201 that is stored in a cylinder block CB. Noted that, in FIG. 1, the cylinders 201 are arranged in a depth direction of the sheet and that the 201 is shown in FIG. 1.

This cylinder 201 houses a piston 202 that produces reciprocal motion in a vertical direction of the drawing in accordance with explosive power that is generated when air-fuel mixture of gasoline as fuel and intake air is combusted. The reciprocal motion of the piston 202 is converted to rotational motion of a crankshaft 204 via a connecting rod 203 and used as power of the hybrid vehicle 1.

A crank position sensor 205 that can detect a crank angle CA is installed in the vicinity of the crankshaft 204, the crank angle CA representing a rotational angle of the crankshaft 204. This crank position sensor 205 is electrically connected to the ECU 100, and the ECU 100 appropriately refers to the detected crank angle CA. This crank angle CA is used to calculate an engine speed NE, control fuel injection timing, and the like, for example.

In the engine 200, the air suctioned from the outside is purified by a cleaner, which is not shown, and is then introduced into an intake pipe 206 that is common for all the cylinders.

A throttle valve 207 is disposed in the intake pipe 206. Together with an actuator, which is not shown and drives the throttle valve 207 for opening and closing, the throttle valve 207 constitutes a known electronically controlled throttle device. This actuator is electrically connected to the ECU 100, and opening and closing operations of the throttle valve 207 are controlled by the ECU 100.

An intake pipe pressure sensor 208 that is configured to be able to detect an intake pipe pressure Pim, which is a pressure of the intake pipe 206, is installed on a downstream side of the throttle valve 207. The intake pipe pressure sensor 208 is electrically connected to the ECU 100, and the ECU 100 appropriately refers to the detected intake pipe pressure Pim.

An intake port 209 that communicates with each of the cylinders is formed on a downstream side of an installed section of the intake pipe pressure sensor 208. The intake air that has passed the throttle valve 207 passes this intake port 209 that corresponds to each of the cylinders 201, and is suctioned into each of the cylinders 201 during opening of an intake valve 211, opening and closing timing of which is determined in accordance with a cam profile of an intake cam 210, the intake cam 210 having a substantially oval shape in a cross-sectional view.

Here, in the intake port 209, a fuel injection valve of an intake port injector 212 for injecting the fuel is exposed. The intake port injector 212 is connected to a fuel tank and a fuel supply passage, which are not shown. The intake port injector 212 can supply spray of the gasoline as the fuel to the intake port 209 at appropriately timing since opening and closing operations of the fuel injection valve are controlled by the ECU 100. The gasoline that is injected from the intake port injector 212 is suctioned as the air-fuel mixture, in which the intake air and the gasoline are mixed, into each of the cylinders 201.

Noted that the appropriate timing is timing at which the gasoline is mixed with the intake air evenly and suctioned as the even air-fuel mixture into each of the cylinders 201. Here, the appropriate timing varies in accordance with a fuel injection amount, the engine speed NE, and the like. Noted that fuel injection to the intake port 209 is a known operation that is normally done in the gasoline engine, and the details of which will not be described herein.

In a combustion chamber of the cylinder 201, a spark plug of an igniter 219 is exposed. The igniter 219 is a known spark type igniter, and can produce a spark for ignition in the spark plug in accordance with a control signal that is supplied from the electrically connected ECU 100. Ignition timing of the igniter 219 is controlled by the ECU 100 in accordance with any of various types of known ignition timing control.

The air-fuel mixture is ignited by an ignition operation of the igniter 219 during a compression stroke, for example, and combusted during a combustion stroke, for example. During an exhaust stroke that follows the combustion stroke, the air-fuel mixture is exhausted to an exhaust port 215 during opening of an exhaust valve 214. The exhaust valve 214 is driven to be opened and closed by following opening and closing timing thereof that is defined in accordance with a cam profile of an exhaust cam 213, the exhaust cam 213 being indirectly coupled to the crankshaft 204.

The exhaust port 215 in each of the cylinders communicates with an exhaust pipe 216 via an exhaust manifold, which is not shown. A catalytic device 217 as an example of the “catalytic device” according to the present invention is installed in the exhaust pipe 216.

The catalytic device 217 is a known three-way catalyst as an example of the “catalytic device” according to the present invention, in which a noble metal, such as platinum, is carried on a catalyst carrier, for example. The catalytic device 217 is configured to be able to purify the exhaust gas by causing a reduction reaction of nitrogen oxide NOx and oxidation and combustion reactions of total hydrocarbon (THC) and carbon monoxide CO, which are non-combusted compositions, at the substantially same time when a catalyst atmosphere is in a state near a stoichiometric condition (for example, an air-fuel ratio=14.7±about 0.2).

In the engine 200, a coolants temperature sensor 218 that can detect a coolant temperature Tw as a temperature of a coolant (LLC) is disposed in a water jacket that is installed to surround the cylinder block CB, the coolant being circulated and supplied to cool the engine 200. The coolant temperature sensor 218 is electrically connected to the ECU 100, and the ECU 100 appropriately refers to the detected coolant temperature Tw.

Noted that the multicylinder gasoline engine is used as the engine 200 in this embodiment. However, configurations of the engine 200 can freely be selected, such as the number of cylinders, arrangement of cylinders, a fuel type, a fuel supply mode, a configuration of a drive valve system, and presence or absence of a supercharger.

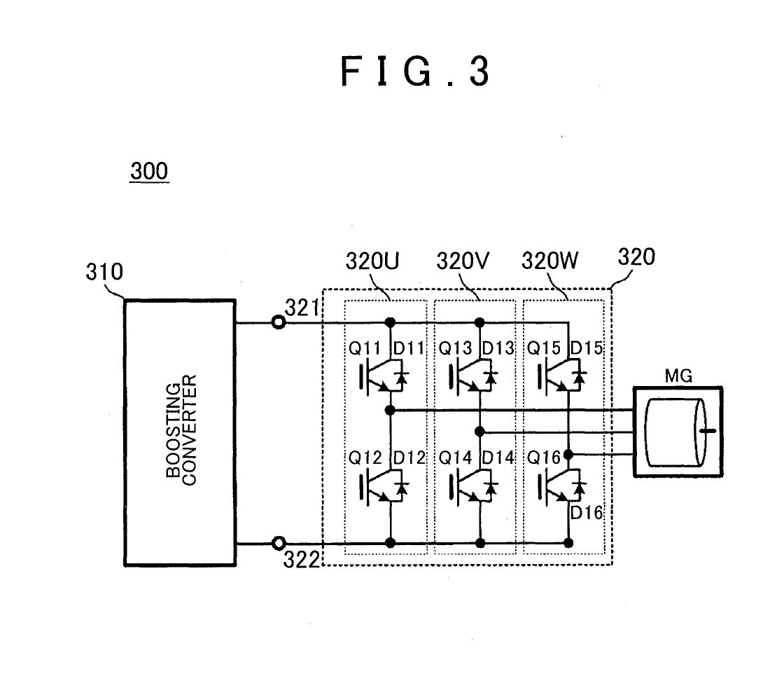

Returning to FIG. 1, the PCU 300 is a power control unit for controlling a driving state of the motor generator MG. A configuration of the PCU 300 will be described below with reference to FIG. 3.

The ECT 400 is a known stepped transmission that has a plurality of physical speed-changing gears between an input shaft IS and a drive shaft DS, the input shaft IS being coupled to the crankshaft 204 of the engine 200 and the drive shaft DS being coupled to the reduction gear mechanism RG. This plurality of physical speed-changing gears is configured such that rotational speed ratios between the input shaft IS and the drive shaft DS, that is, speed-changing ratios differ from each other and that the gear is appropriately switched by the ECU 100.

The motor generator MG is a three-phase alternate-current (AC) motor generator as an example of the “motor” according to the present invention. The motor generator MG has a power generation function for converting electrical energy to kinetic energy and a regeneration function for converting kinetic energy to electrical energy.

An output rotational shaft of the motor generator MG is coupled to the above-described drive shaft DS. An output rotational speed Nout, which is a rotational speed of the drive shaft DS, is equal to an MG rotational speed Nmg, which is a rotational speed of the motor generator MG. Noted that a reduction gear or a transmission may appropriately be interposed between the motor generator MG and the drive shaft DS.

A resolver rv for detecting a rotational angle of the motor generator MG is added to the output rotational shaft of the motor generator MG. The rotational angle of the motor generator MG that is detected by this resolver rv is used for calculation of the MG rotational speed Nmg.

The reduction gear mechanism RG is a gear device that is interposed between the drive shaft DS and drive wheels DW and includes various reduction gears, a differential, and the like.

The first power supply B1 is a DC power supply device at a power supply voltage VB1 (200V, for example), in which a plurality (hundreds, for example) of any of various types of secondary battery cells (of a cell voltage V, for example), such as nickel-hydrogen batteries and lithium-ion batteries, are connected in series. The first power supply B1 is an example of the “first power supply” according to the present invention.

The second power supply B2 is an electric double-layered capacitor, for example, and is a DC power supply device at a power supply voltage VB2. The second power supply B2 is an example of the “second power supply” according to the present invention.

Noted that the first power supply B1 and the second power supply B2 have different configurations from each other in this embodiment. However, these may not necessarily be different from each other. In addition, as these DC power supplies, configurations such as a large-capacity capacitor and a flywheel can be adopted in addition to these types of the secondary batteries and the electric double-layered capacitor.

Next, a configuration of the PCU 300 will be described with reference to FIG. 3. Here, FIG. 3 is a schematic configuration diagram of the PCU 300. Noted that, in this drawing, portions that overlap with those in FIG. 1 are denoted by the same reference numerals and descriptions thereof will appropriately be omitted.

In FIG. 3, the PCU 300 is a power control unit that is configured to be able to control input and output of power between the motor generator MG and each of the first power supply B1 and the second power supply B2 and that includes a boosting converter 310 and an inverter 320.

The inverter 320 is a switching device as an example of the “load” according to the present invention, and includes a U-phase arm 320U, a V-phase arm 320V, and a W-phase arm 320W that are connected in parallel between a power supply wire 321 and a ground wire 322.

The U-phase arm 320U includes a positive-side switching element Q11 and a negative-side switching element Q12. The V-phase arm 320V includes a positive-side switching element Q13 and a negative-side switching element Q14. The W-phase arm 320W includes a positive-side switching element Q15 and a negative-side switching element Q16. Each of the switching elements is configured as an insulated gate bipolar transistor (IGBT) with a self-protection circuit, for example. However, each of these switching elements may be a power metal oxide semiconductor (MOS) transistor or the like.

Noted that rectifying diodes D11 to D16, each of which passes the current from an emitter side to a collector side, are respectively connected to the switching elements Q11 to Q16. An electrical connecting point between an upper arm (the positive-side switching element) and a lower arm (the negative-side switching element) in each of the phase arms of the inverter 320 is connected to each of phase coils of the motor generator MG.

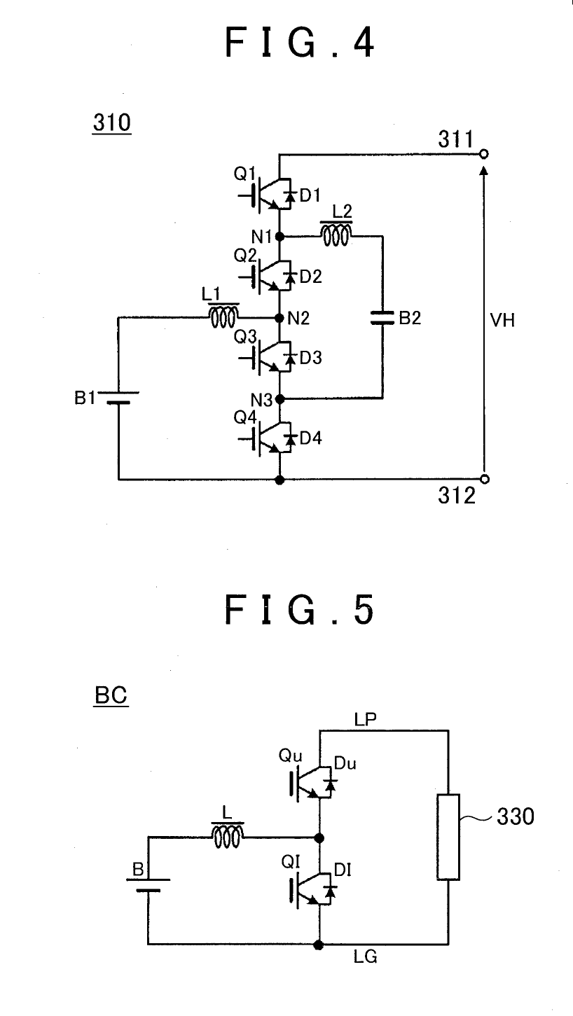

Next, a configuration of the boosting converter 310 will be described with reference to FIG. 4. Here, FIG. 4 is a schematic circuit diagram of the boosting converter 310. Noted that, in this drawing, portions that overlap with those in FIG. 1 are denoted by the same reference numerals and descriptions thereof will appropriately be omitted.

The boosting converter 310 is an example of the “power converter” according to the present invention that includes reactors L1 and L2 and switching elements Q1, Q2, Q3, and Q4.

Similar to each of the switching elements in the above-described inverter 320, each of the switching elements in the boosting converter 310 is configured as the IGBT with the self-protection circuit, the power MOS transistor, or the like. In addition, rectifying diodes D1 to D4, each of which passes the current from the emitter side to the collector side, are respectively connected to the switching elements Q1 to Q4. Noted that a switching state (that is, an ON/OFF state) of each of these switching elements in the boosting converter 310 is controlled in accordance with a control signal that is supplied from the ECU 100.

A power supply wire 311 and a ground wire 312 of the boosting converter 310 are respectively connected to the power supply wire 321 and the ground wire 322 of the above-described inverter 320. A potential difference between the power supply wire 321 and the ground wire 322 corresponds to an output voltage VH of the boosting converter 310.

In the boosting converter 310, the switching element Q1 is electrically connected between the power supply wire 311 and a node N1. The switching element Q2 is electrically connected between the node N1 and a node N2. The switching element Q3 is electrically connected between the node N2 and a node N3. The switching element Q4 is electrically connected between the node N3 and the ground wire 312.

In addition, in the boosting converter 310, the reactor L1 is electrically connected between the node N2 and a positive electrode terminal of the first power supply B1. The reactor L2 is electrically connected between the node N1 and a positive electrode terminal of the second power supply B2.

The boosting converter 310 includes boosting circuits that respectively correspond to both of the first power supply B1 and the second power supply B2. These boosting circuits are formed by the above reactors L1 and L2, the switching elements Q1 to Q4, and the rectifying diodes D1 to D4.

Next, an operation of the embodiment will be described.

First, in order to explain boosting principle of a DC power supply voltage in the boosting converter 310, a description will be made on a general boosting circuit with reference to FIG. 5. Here, FIG. 5 is a circuit diagram of the general boosting circuit.

In FIG. 5, a general boosting circuit BC is exemplified. The boosting circuit BC includes a switching element Qu of an upper arm (hereinafter, appropriately expressed as the “upper arm element Qu”), a switching element Q1 of a lower arm (hereinafter, appropriately expressed as a “lower arm element Q1”), and a reactor L. The boosting circuit BC is connected to a load 330.

The reactor L is electrically connected between a positive electrode terminal of a DC power supply B and a connection point between the upper arm element Qu and the lower arm element Q1. The upper arm element Qu and the lower arm element Q1 are inserted in series between a power supply wire LP and a ground wire LG.

In the boosting circuit BC with such a configuration, an ON period of the upper arm element Qu and an ON period of the lower arm element Q1 are alternately provided. Noted that, during the ON period of one element, the other element is OFF.

Here, during the ON period of the lower arm element Q1, a current path that runs through the DC power supply B, the reactor L, and the lower arm element Q1 is formed. Thus, energy is stored in the reactor L. On the other hand, during the ON period of the upper arm element Qu when the lower arm element Q1 is OFF, a current path that runs through the DC power supply B, the reactor L, the upper arm element Qu, and the load 330 is formed. Accordingly, the energy stored in the reactor L during the ON period of the lower arm element Q1 and energy from the DC power supply B are supplied to the load 330. As a result, an output voltage to the load 330 (that is, a voltage between the power supply wire LP and the ground wire LG) is boosted with respect to a power supply voltage of the DC power supply B.

In addition, during the ON period of the upper arm element Qu, bidirectional power transfer is possible between the load 330 and the upper arm element Qu. In other words, the upper arm element Qu can also receive regenerative power from the load 330 side.

An output voltage VH of the boosting circuit BC is defined by the following expression (1) that uses a power supply voltage VB of the DC power supply B and a duty ratio DT of the lower arm element Q1

VH=1/(1−DT)×VB (1)

Accordingly, a boosting ratio r of the boosting circuit BC (that is, VH/VB) can be given by the following expression (2).

r=1/(1−DT) (2)

In the general boosting circuit, for example, the power supply voltage VB is boosted as described above.

In FIG. 4, an upper arm element that corresponds to the upper arm element Qu in the above-described general the boosting circuit is formed at a position between the first power supply B1 and the power supply wire 311 by the switching elements Q1 and Q2. Meanwhile, a lower arm element that corresponds to the lower arm element Q1 in the above-described general the boosting circuit is formed at a position by the switching elements Q3 and Q4. A first boosting circuit is formed by these.

Similarly, in FIG. 4, a lower arm element that corresponds to the lower arm element Q1 in the above-described general boosting circuit is formed at a position between the second power supply B2 and the power supply wire 311 by the switching elements Q2 and Q3. In addition, an upper arm element that corresponds to the upper arm element Qu in the above-described general boosting circuit is formed by the switching elements Q1 and Q4. A second boosting circuit is formed by these.

In the boosting converter 310, as described above, both of the first and second boosting circuits are formed by the switching elements Q1 to Q4. In other words, the switching elements Q1 to Q4 are contained in both of a power conversion path between the first power supply B1 and the power supply wire 311 by the first boosting circuit and a power conversion path between the second power supply B2 and the power supply wire 311 by the second boosting circuit.

The boosting converter 310 is operated in one operation mode of two operation modes by control of the switching state of each of the switching elements Q1 to Q4, the two operation modes including: a series mode in which the first power supply B1 and the second power supply B2 are electrically connected in series with respect to the load (that is, the inverter 320); and a parallel mode in which the first power supply B1 and the second power supply B2 are electrically connected in parallel with respect to the load. The series mode is an example of the “first operation mode” according to the present invention, and the parallel mode is an example of the “second operation mode” according to the present invention.

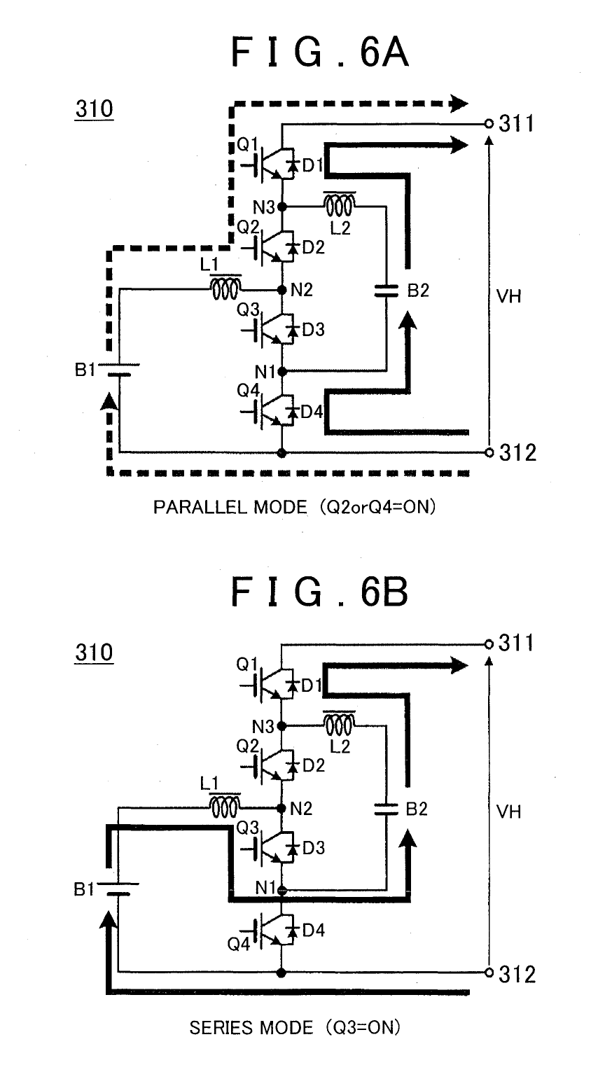

Here, the series mode and the parallel mode will be described with reference to FIGS. 6A and 6B. Here, FIGS. 6A and 6B are the pattern diagram of current paths in each of the operation modes of the boosting converter. Noted that, in this drawing, portions that overlap with those in FIG. 4 are denoted by the same reference numerals and descriptions thereof will appropriately be omitted.

FIG. 6A shows an output current path of the boosting converter 310 in the parallel mode (that is, a current circulation path with respect to the reactor).

In the parallel mode, the switching element Q2 or 04 is controlled in an ON state. Noted that which of the switching elements Q2 and Q4 is turned ON is determined in accordance with a magnitude relation between the power supply voltage VB1 of the first power supply B1 and the power supply voltage VB2 of the second power supply B2. That is, when the magnitude relation of VB1>VB2 is established (when the power supply voltage of the first power supply B1 is larger), the switching element Q2 is turned ON. On the contrary, when the magnitude relation of VB2>VB1 is established (when the power supply voltage of the second power supply B2 is larger), the switching element Q4 is turned ON.

When the magnitude relation of VB1>VB2 is established, and thus the switching element Q2 is controlled in the ON state, the first power supply B1 and the second power supply B2 are electrically connected in parallel via the switching elements Q3 and Q4.

In this case, the output current path of the first boosting circuit that corresponds to the first power supply B1 (that is, the current circulation path with respect to the reactor L1) becomes to a path that runs through the rectifying diode D2, the rectifying diode D1, the power supply wire 311, the load (the inverter 320 and the motor generator MG), and the ground wire 312 (see a path that is shown by a broken line). In addition, the output current path of the second boosting circuit that corresponds to the second power supply B2 (that is, the current circulation path with respect to the reactor L2) becomes a path that runs through the rectifying diode D1, the power supply wire 311, the load, the ground wire 312, and the rectifying diode D4 (see a path that is shown by a solid line).

Noted that the description is made here on the current paths during power generation driving of the motor generator MG that constitutes a part of the load. As for a time during regeneration driving, the switching element Q1 for regeneration control is turned ON. The current is circulated in the current path that runs through the rectifying diodes D4 and D3 for the reactor L1 and in the current path that runs through the rectifying diode D3 for the reactor L2.

Also, in this case, as for the above-described first boosting circuit that corresponds to the first power supply B1, the ON period of the lower arm element and the ON period of the upper arm element can alternatively be set by controlling both of the switching elements Q3 and Q4 to the ON states or the OFF states. As for the second boosting circuit that corresponds to the second power supply B2, the ON period of the lower arm element and the ON period of the upper arm element can alternatively be set by controlling the switching element Q3 to the ON state or the OFF state. In other words, in the parallel mode, the power source voltages of the first-power supply B1 and the second power supply B2 can be boosted in an independent manner from each other.

On the other hand, when the magnitude relation of VB2>VB1 is established, and thus the switching element Q4 is controlled in the ON state, the first power supply B1 and the second power supply B2 are electrically connected in parallel via the switching elements Q2 and Q3.

In this case, the output current path of the first boosting circuit that corresponds to the first power supply B1 becomes a path that runs through the rectifying diode D2, the rectifying diode D1, the power supply wire 311, the load, and the ground wire 312 (see the path that is shown by the broken line). In addition, the output current path of the second boosting circuit that corresponds to the second power supply B2 becomes a path that runs through the rectifying diode D1, the power supply wire 311, the load, the ground wire 312, and the rectifying diode D4 (see the path that is shown by the solid line).

Noted that the description is made here on the current paths during power generation driving of the motor generator MG that constitutes a part of the load. As for the time during regeneration driving, the switching element Q1 for the regeneration control is turned ON. The current is circulated in the current path that runs through the rectifying diode D3 for the reactor L1 and in the current path that runs through the rectifying diodes D3 and D2 for the reactor L2.

Also, in this case, as for the above-described first boosting circuit that corresponds to the first power supply B1, the ON period of the lower arm element and the ON period of the upper arm element can alternatively be set by controlling the switching element Q3 to the ON state or the OFF state. As for the second boosting circuit that corresponds to the second power supply B2, the ON period of the lower arm element and the ON period of the upper arm element can alternatively be set by controlling both of the switching elements Q2 and Q3 to the ON state or the OFF state. In other words, in the parallel mode, the power source voltages of the first power supply B1 and the second power supply B2 can be boosted in the independent manner from each other.

FIG. 6B shows the output current path of the boosting converter 310 in the series mode (that is, the current circulation path with respect to the reactor).

In the series mode, the switching element Q3 is controlled in the ON state. When the switching element Q3 is controlled in the ON state, the first power supply B1 and the second power supply B2 are electrically connected in series with respect to the power supply wire 311. In other words, in the boosting converter 310, the output current flows in a path that is shown by a solid line.

In addition, in the series mode, the ON period of the lower arm element and the ON period of the upper arm element can alternatively be set by controlling both of the switching elements Q2 and Q4 to the ON states or the OFF states. In other words, in the series mode, the power source voltages of the first power supply B1 and the second power supply B2 can be boosted.

A system maximum output value Wmax that is a maximum output value of the boosting converter 310 can differ between a time when the operation mode is the parallel mode and a time when the operation mode is the series mode.

A system maximum output value Wmaxp of the boosting converter 310 in the parallel mode is defined by the following expression (3).

Wmaxp=Woutb1+Woutb2 (3)

Here, Woutb1 is an output limit value of the first power supply B1. Woutb1 is defined by the power supply voltage VB1 of the first power supply B1 and a maximum output current value per unit time of the first power supply B1. This maximum output current value is an inherent value to the first power supply B1, and is influenced by a temperature of the first power supply B1. Thus, the maximum output current value is relatively lowered when the temperature of the first power supply B1 is low or high with respect to a certain reference range.

Woutb2 is an output limit value of the second power supply B2. Woutb2 is defined by the power supply voltage VB2 of the second power supply B2 and the maximum output current value per unit time of the second power supply B2. This maximum output current value is an inherent value to the second power supply B2, and is influenced by a temperature of the second power supply B2. Thus, the maximum output current value is relatively lowered when the temperature of the second power supply B2 is low or high with respect to a certain reference range.

As described above, in the parallel mode, the maximum output of each of the power supplies is supplied to the load.

Meanwhile, a system maximum output value Wmaxs of the boosting converter 310 in the series mode is defined by the following expression (4) or expression (5).

Wmaxs=Woutb1+Woutb2′ (4)

Wmaxs=Woutb1′+Woutb2 (5)

Here, Woutb1′ is a permissible output limit value of the first power supply B1, and Woutb2′ is a permissible output limit value of the second power supply B2.

As shown in FIG. 6B, in the series mode, the first power supply B1 and the second power supply B2 are electrically connected in series with respect to the power supply wire 311. Accordingly, the maximum output current value of the boosting converter 310 is restricted to smaller one of the maximum output current value of the first power supply B1 and the maximum output current value of the second power supply B2.

The above expression (4) corresponds to a case where the maximum output current value of the first power supply B1 is smaller than the maximum output current value of the second power supply B2. That is, the above expression (4) corresponds to a case where the maximum output current value of the second power supply B2 is restricted to the maximum output current value of the first power supply B1. In other words, in this case, the second power supply B2 cannot necessarily output the output limit value Woutb2, and the maximum output value thereof, becomes the permissible output limit value Woutb2′ that is at most equal to the output limit value Woutb2.

The above expression (5) corresponds to a case where the maximum output current value of the second power supply B2 is smaller than the maximum output current value of the first power supply B1. That is, the above expression (5) corresponds to a case where the maximum output current value of the first power supply B1 is restricted to the maximum output current value of the second power supply B2. In other words, in this case, the first power supply B1 cannot necessarily output the output limit value Woutb1, and the maximum output value thereof becomes the permissible output limit value Woutb1′ that is at most equal to the output limit value Woutb1.

As apparent from the above expressions (3) and (4) or (5), the parallel mode is superior to the series mode in terms of the system maximum output.

Meanwhile, in the series mode, when load conditions are the same, the current flowing through the switching elements Q1 to Q4 of the boosting converter 310 is smaller than that in the parallel mode. This is because a DC voltage of the boosting converter 310 in the series mode is converted with respect to a sum of the power supply voltages of both of the DC power supplies (that is, VB1+VB2). In the parallel mode, a sum of the current that is generated by the DC voltage conversion with respect to the power supply voltage VB1 and the current that is generated by the DC voltage conversion with respect to the power supply voltage VB2 flows through each of the switching elements. Accordingly, the current flowing through the switching elements is larger than that in the series mode. Thus, boosting loss in the series mode (electric loss in conjunction with a switching operation of each of the switching elements) is lower than that in the parallel mode. In other words, the series mode is an operation mode in a higher efficiency than the parallel mode.

Noted that, from another perspective, in the parallel mode, even when a situation arises where it is difficult to secure the output of one of the DC power supplies, the output of the other DC power supply can be provided to obtain energy that is required to drive the load. In other words, the parallel mode is superior to the series mode in terms of stability. In addition, from yet another perspective, in the series mode, the stored energy in one of the DC power supplies can be used up. Thus, the series mode is superior to the parallel mode in terms of efficient use of energy.

Effects of each of these operation modes are merely examples. Various advantages and disadvantages of each of the series mode and the parallel mode are known.

In order for the catalytic device 217 included in the engine 200 to exert the exhaust purification performance expected in advance therefor, in addition to the air-fuel ratio of the gas with the catalyst that flows into the catalytic device 217, a temperature of the catalytic device 217 (hereinafter, appropriately expressed as a “catalyst temperature”) is important. More specifically, a catalyst activation temperature is set for the catalytic device 217. In an unwarm state that the catalyst temperature is lower than the catalyst activation temperature, exhaust purification efficiency of the catalytic device 217 is lowered. Thus, in the engine 200, catalyst warm-up control is executed during an unwarm period of the catalytic device 217. The catalyst warm-up control is an example of the “warm-up promotion control” according to the present invention.

The catalyst warm-up control is, simply speaking, control for increasing a temperature of the gas with the catalyst (that is, the exhaust). In other words, all types of control that are associated with an increase in the exhaust temperature can be handled as the catalyst warm-up control according to the present invention. For example, the catalyst warm-up control includes retardation control of the ignition timing, imbalance control of the air-fuel ratio, and the like.

The retardation control of the ignition timing is control for delaying the ignition timing in the igniter 219 in comparison with a normal time. During normal control of the engine 200, the ignition timing is controlled to a value (for example, minimum advance for best torque (MBT)) that is optimized in advance for a driving condition so that engine torque Te becomes the maximum. When the ignition timing is delayed with respect to this optimum ignition timing, combustion efficiency is lowered. As a result, a relatively large amount of non-combusted gas is supplied to the exhaust pipe 216. In addition, when the ignition timing is delayed, a combustion period is also delayed in the retardation side. Thus, the temperature of the exhaust from the cylinder becomes relatively high. As a result, this non-combusted gas is combusted in the exhaust pipe 216. That is, the retardation of the ignition timing is control in which a part of combustion heat that should normally be extracted as the kinetic energy is used to increase the exhaust temperature.

In addition, upon execution of the retardation control of the ignition timing, such a measure may be taken that an intake air amount is increased to be larger than usual by controlling the throttle valve 207, so as to secure an amount of oxygen that is sufficient for oxidation and combustion of the non-combusted compositions.

Meanwhile, the imbalance control of the air-fuel ratio is air-fuel ratio control for the each cylinder that can be realized in a multicylinder engine. In other words, in order to secure the exhaust purification efficiency of the catalytic device 217, the atmosphere of the catalytic device 217 needs to be in the state near the stoichiometric condition. In other words, the air-fuel ratio of the gas with the catalyst is desirably in the state near the stoichiometric condition.

However, a method for keeping the air-fuel ratio of the gas with the catalyst to the state near the stoichiometric condition is not limited to controlling the controlled air-fuel ratios of all the cylinders to the states near the stoichiometric condition. In other words, the controlled air-fuel ratio is set to be richer than a stoichiometric ratio for some of the cylinders, while the controlled air-fuel ratio is set to be leaner than the stoichiometric ratio for the other cylinders. Accordingly, the air-fuel ratio of the entire gas with the catalyst can be kept to the state near the stoichiometric condition.

As described above, when the controlled air-fuel ratio is varied by the cylinder, an excess amount of O₂ is exhausted from the cylinder whose air-fuel ratio is leaner than the stoichiometric ratio, that is, a high air excess ratio, and HC and CO as non-combusted or incompletely combusted compositions are exhausted from the cylinder whose air-fuel ratio is richer than the stoichiometric ratio, that is, the low air excess ratio. Since these components cause the oxidation and combustion reactions in the exhaust pipe 216 or the catalytic device 217, they can heat the catalytic device 217.

Noted that the imbalance control of the air-fuel ratio is executed by referring to an output value of a sensor that can detect a value corresponding to the air-fuel ratio, such as an air-fuel ratio sensor and an O2 sensor, which are not shown in FIG. 2.

The catalyst warm-up control is executed in accordance with a catalyst warm-up request as a control signal. The catalyst warm-up request is made in the following case, for example.

When the catalyst temperature is lower than a specified value, the specified value refers to, for example, the catalyst activation temperature that is a temperature at which the higher exhaust purification efficiency than specified efficiency can be achieved in the catalytic device 217. When the catalyst temperature is used as a determination index, a sensor for detecting the catalyst temperature and the like are installed in the hybrid vehicle 1. Noted that, when the catalyst temperature can be estimated under another condition, there is no need to install the sensor and the like, and this estimated catalyst temperature may be used for the control. When the catalyst temperature is used as the determination index, needless to say, the warm state of the catalytic device 217 can be determined most accurately.

When the coolant temperature is lower than a specified value, the coolant temperature Tw of the engine 200 can be used as an alternative index for the catalyst temperature. Although the coolant temperature Tw and the catalyst temperature are in a constant correlation with each other, they are not necessarily in an unambiguous relation. Thus, when the coolant temperature is used as the determination index, determination accuracy on whether the catalytic device 217 is in the unwarm state is lowered than the case described in the above paragraph. However, when the coolant temperature Tw is used as the determination index, there is no need of providing a special device configuration for detecting the catalyst temperature. Thus, this case has an advantage in terms of cost.

Noted that, when the coolant temperature is used as the determination index, a condition to terminate the catalyst warm-up control, that is, a condition to cancel the catalyst warm-up request may be defined by length of an execution period of the catalyst warm-up control. In other words, if driving conditions of the engine (for example, the intake air amount, the engine speed, the fuel injection amount, and the like) in the catalyst warm-up control are known, an amount of heat that is supplied to the catalytic device 217 per unit time during the catalyst warm-up control can also be known. If the amount of heat that is required for the catalytic device 217 to reach a catalyst activation state from a cold state is known, it becomes possible with the length of the execution period of the catalyst warm-up control to determine whether the catalytic device 217 has been shifted to the warm state.

The hybrid vehicle 1 has a plurality of travel modes. Here, as an example of such travel modes, an EV travel mode and an HV travel mode will be described.

The EV travel mode is a travel mode in which drive shaft requested torque Tdn that is requested to the drive shaft DS is covered only by MG torque Tmg that is output torque of the motor generator MG. In the EV travel mode, the hybrid vehicle 1 can perform an EV travel.

Here, in the EV travel mode, the ECT 400 is maintained in a neutral state. In the neutral state, power transmission in the ECT 400 is blocked. That is, the rotation of the input shaft IS is not transmitted to the drive shaft DS. When such a configuration is adopted, the lowered efficiency that is caused by friction of the engine 200 can be suppressed during the EV travel. In addition, in view of the configuration that the rotation of the engine is not transmitted to the drive shaft DS, the above-described catalyst warm-up control can be executed in the EV travel mode.

Meanwhile, the HV travel mode is a travel mode in which the engine 200 is used as a primary power supply source for the drive shaft DS and the motor generator MG is used as an auxiliary power source. In other words, in the HV travel mode, the hybrid vehicle 1 can perform an HV travel by controlling the engine 200 and the motor generator MG collaboratively.

In the hybrid vehicle 1, regardless of a mode of the catalyst warm-up control, the HV travel in which the engine torque Te is supplied to the drive shaft DS should be avoided as much as possible before the catalyst warm-up control is completed. When the engine 200 is actuated before the completion of the catalyst warm-up control, the exhaust purification performance of the catalytic device 217 is not sufficient. Accordingly, the emissions of the hybrid vehicle 1 may be deteriorated. Actuation mentioned here has a different meaning from actuation or activation for the catalyst warm-up control. In addition, the unwarm period of the catalytic device 217 overlaps a cold period of the engine 200 in many cases. Since the combustion efficiency of the engine 200 in the cold state is low, fuel consumption efficiency generally tends to be deteriorated. Also in this point, continuation of the EV travel is desired during the execution period of the catalyst warm-up control.

Accordingly, the operation modes of the boosting converter 310 have to be managed such that the travel mode of the hybrid vehicle 1 is not shifted to the HV travel mode during the catalyst warm-up control. In this embodiment, such management is realized by the operation mode control that is executed by the ECU 100.

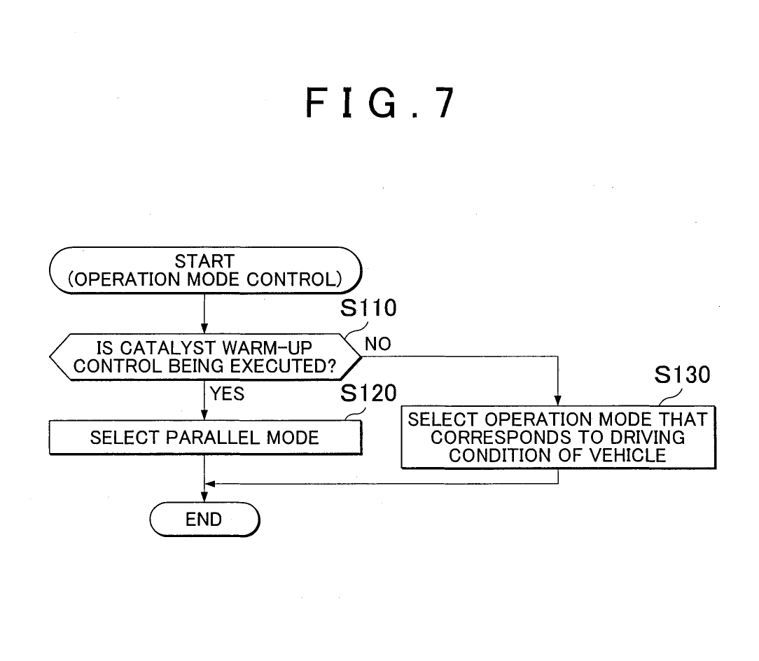

Here, the operation mode control will be described with reference to FIG. 7. Here, FIG. 7 is a flowchart of the operation mode control. Noted that the operation mode control is an example of operation control of the boosting converter 310 that is executed by the ECU 100.

In FIG. 7, the ECU 100 determines whether the catalyst warm-up control is being executed (step S110). As described above, the catalyst warm-up control is executed separately by the ECU 100 in accordance with the various conditions.

If the catalyst warm-up control is being executed (step S110: YES), the ECU 100 selects the parallel mode as the operation mode of the boosting converter 310 (step S120). In other words, each of the switching elements Q1 to Q4 of the boosting converter 310 is controlled to be in the switching state that corresponds to the parallel mode that has already been described.

On the contrary, if the catalyst warm-up control is not being executed (step S110: NO), simply speaking, when warming of the catalyst is completed, the ECU 100 controls the operation mode of the boosting converter 310 to the operation mode that corresponds to the driving condition of the hybrid vehicle 1 (step S130). The operation mode control is terminated once either step S120 or S130 is executed.

Noted that the operation mode that corresponds to the driving condition of the hybrid vehicle 1 will not be described here. In other words, it is defined in step S130 that there is at least no correlation between the state of the catalytic device 217 and the operation mode of the boosting converter 310. It is because such an operation mode can be set in any way on the basis of the above-described effects of each of the operation modes.

Noted that, if a supplementary description is made here, the series mode has an advantage over the parallel mode when the efficiency of the boosting converter 310 is taken into consideration. The efficiency tends to be emphasized for the hybrid vehicle. In this point, it is usually preferred to operate the boosting converter 310 in the series mode. That is, the operation mode that corresponds to the driving condition of the vehicle in step S130 can mean the series mode in many cases.

Meanwhile, as it has already been described, the one output current value is restricted to the other maximum output current value in the series mode. Accordingly, there is a case where the parallel mode, the system maximum output value Wmax of which is large, is advantageous over the series mode, such as when the relatively large output is requested to the motor generator MG during a high load travel and the like. In such a case, the parallel mode can be selected as the operation mode that corresponds to the driving condition of the vehicle in step S130.

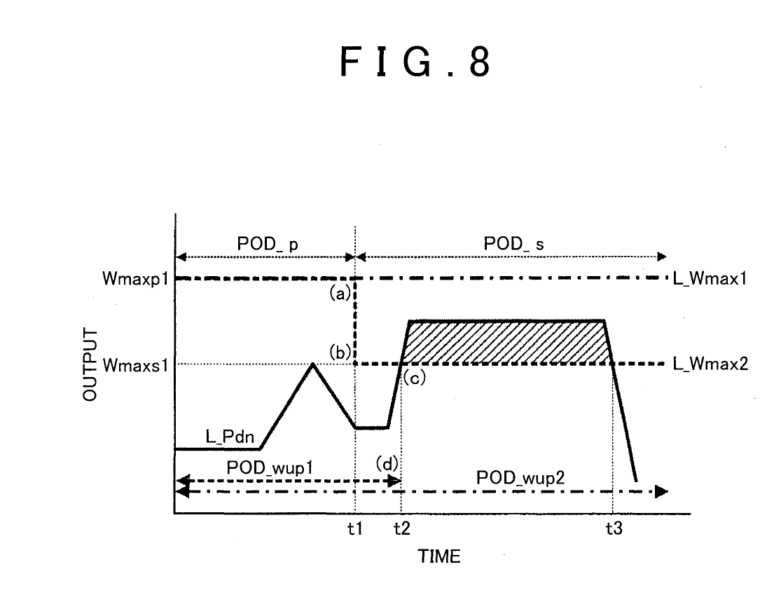

Here, effects of the operation mode control will be described with reference to FIG. 8. FIG. 8 is a chart for exemplifying temporal transitions of various types of the output in the execution period of the operation mode control.

In FIG. 8, a vertical axis indicates the output, and a horizontal axis indicates time. In addition, a temporal transition of drive shaft requested output Pdn that represents output requested to the drive shaft DS is indicated by L_Pdn in the drawing (see a solid line). Noted that the drive shaft requested output Pdn is obtained by converting requested driving force Ft of the hybrid vehicle 1 to an output value. The drive shaft requested output Pdn may be treated as being equivalent to requested output Pn of the hybrid vehicle 1 when requested power by various electric auxiliary machines included in the hybrid vehicle 1 is ignored.

In a time region before time t1 in FIG. 8, it is set that the operation mode of the boosting converter 310 is the parallel mode (see POD_p in the drawing). In this case, the system maximum output value Wmax of the boosting converter 310 becomes a system maximum output value Wmaxp1 that is according to Wmaxp defined by the above expression (3).

Here, at the time t1, it is set that the operation mode of the boosting converter 310 is switched to the series mode (see (a) in the drawing). In other words, in a time region on and after the time t1, the operation mode of the boosting converter 310 becomes the series mode (see POD_s in the drawing).

Once the operation mode is switched to the series mode, the system maximum output value Wmax of the boosting converter 310 is reduced to a system maximum output value Wmaxs1 (Wmaxs1<Wmaxp1) that is according to Wmaxs defined by the above expression (4) or (5) (see (b) in the drawing). A temporal transition of the system maximum output value Wmax in this case is indicated by L_Wmax2 in the drawing (see a broken line).

Here, if the system maximum output value Wmaxs1 and the drive shaft requested output Pdn are compared, a relation of Pdn<Wmaxs1 is established in the time region before time t2. In other words, the entire drive shaft requested output Pdn can theoretically be covered by the output of the motor generator MG.

Meanwhile, when Pdn=Wmax1 is established at the time t2 (see (c) in the drawing), a relation of Pdn>Wmaxs1 is established in a time region from the time t2 to time t3. In other words, the entire drive shaft requested output Pdn can no longer be covered by the output of the motor generator MG. Visually, a hatched portion in the drawing where L_Pdn exceeds L_Wmax2 in the drawing corresponds to an output shortage with respect to the requested output.

In other words, if it is assumed that the hybrid vehicle 1 is in the EV travel in the time region before the time t2, in a situation exemplified in FIG. 8, the travel mode of the hybrid vehicle 1 needs to be switched to the HV travel mode at the time t2.

Accordingly, if it is assumed that the catalyst warm-up control is executed in the time region before the time t2, the catalyst warm-up control is terminated at the time t2 (see (d) in the drawing). That is, a catalyst warm-up period corresponds to POD_wup1 in the drawing (see a broken line). If the catalytic device 217 has not reached to be in the warm state (that is, the catalyst activation temperature), emissions of the hybrid vehicle 1 are deteriorated.

On the contrary, according to the operation mode control of this embodiment, the operation mode of the boosting converter 310 is kept in the parallel mode or switched during the execution period of the catalyst warm-up control. That is, in the situation exemplified in FIG. 8, the operation mode is kept as the parallel mode. As a result, the system maximum output value Wmax of the boosting converter 310 is kept at Wmaxp1. The temporal transition of the system maximum output value Wmax in this case is shown as L_Wmax1 in the drawing (see a chain line).

As shown in the drawing, L_Pdn never exceeds L_Wmax1 in this case. In other words, if it is assumed that the hybrid vehicle 1 is in the EV travel in the time region before the time t2, there is no need to switch the travel mode of the hybrid vehicle 1 to the HV travel mode at the time t2.

Thus, according to the operation mode control of this embodiment, the catalyst warm-up control can be continued in both of the time region before the time t2 and the time region on and after the time t2. Thus, the catalyst warm-up period corresponds to POD_wup2 in the drawing (see a chain line). In other words, according to the operation mode control of this embodiment, the travel mode is not shifted to the HV travel mode in the situation where the catalytic device 217 has not reached to be in the warm state (that is, the catalyst activation temperature). Therefore, the deterioration of the emissions of the hybrid vehicle 1 is prevented.

Noted that, it is configured in this embodiment that the determination on whether the catalyst warm-up control is being executed is made in step S110. However, in some cases, the operation mode of the boosting converter 310 may be controlled to the parallel mode without going through a determination operation on presence or absence of the execution of the catalyst warm-up control.

For example, at a time when the engine is initially started in the hybrid vehicle 1, both of the engine 200 and the catalytic device 217 are highly likely to be in the cold states immediately after the engine start. Under such a condition that it is assumed in advance that the catalytic device 217 is highly likely to be in the cold state, even when the boosting converter 310 is controlled to be in the parallel mode without making the determination on whether the catalyst warm-up control is being executed, the operation of the ECU 100 of the present invention to control the boosting converter 310 to be in the parallel mode during the execution period of the catalyst warm-up control is secured. In other words, the operations of the ECU 100 according to the present invention include an operation that does not go through the determination operation on presence or absence of the execution of the catalyst warm-up control as described above. Noted that the “time when the engine is started” may be a time when the hybrid vehicle is in a READY-ON status. In this case, “immediately after the engine start” may be immediately after READY-ON.

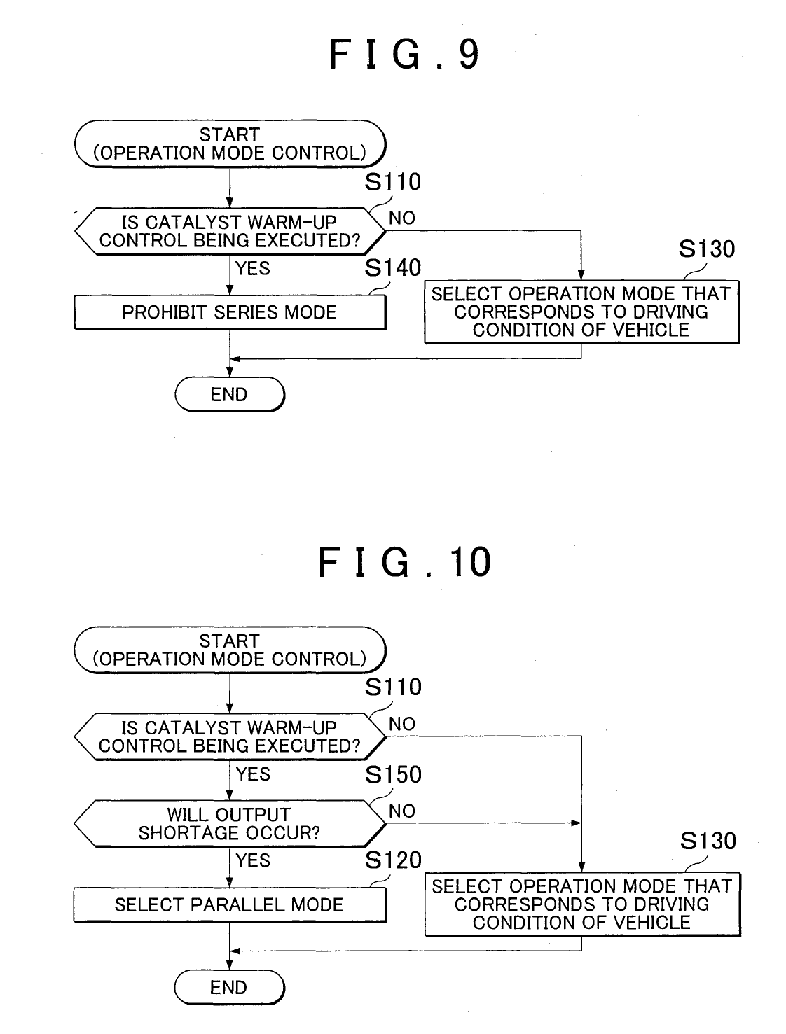

Next, a description will be made on operation mode control according to a second embodiment of the present invention with reference to FIG. 9. Here, FIG. 9 is a flowchart of the operation mode control according to the second embodiment. Noted that, in this drawing, portions that overlap with those in FIG. 7 are denoted by the same reference numerals and descriptions thereof will appropriately be omitted.

In FIG. 9, if the catalyst warm-up control is being executed (step S110: YES), the ECU 100 prohibits the operation of the boosting converter 310 in the series mode (step S140). In other words, when the series mode has been selected as the previous operation mode, the operation mode is unconditionally switched to the parallel mode. In addition, when the parallel mode has been selected as the previous operation mode, the operation mode will never be switched to the series mode for any reason whatsoever.

As described above, according to this embodiment, the operation mode of the boosting converter 310 is controlled to the parallel mode during the catalyst warm-up control like the first embodiment. Accordingly, similar to the first embodiment, generation frequency of the switching request from the EV travel mode to the HV travel mode in the catalyst warm-up period is reduced. Therefore, the deterioration of the emissions of the hybrid vehicle 1 is prevented.

Furthermore, according to this embodiment, the operation in the series mode is prohibited during the catalyst warm-up control. Thus, even when such a determination is established by another requirement that the series mode should be selected, the parallel mode is reliably maintained. In other words, switching from the EV travel mode to the HV travel mode is further strictly prevented.

Next, a description will be made on operation mode control according to a third embodiment of the present invention with reference to FIG. 10. Here, FIG. 10 is a flowchart of the operation mode control according to the third embodiment. Noted that, in this drawing, portions that overlap with those in FIG. 7 are denoted by the same reference numerals and descriptions thereof will appropriately be omitted.

In FIG. 10, if the catalyst warm-up control is being executed (step S110: YES), the ECU 100 determines whether the output shortage will occur (step S150).

Here, a purpose of step S150 will be described. A purpose of setting the operation mode of the boosting converter 310 to the parallel mode in the execution period of the catalyst warm-up control is to prevent a decrease of the system maximum output value Wmax of the boosting converter 310. Furthermore, the purpose is to prevent generation of the switching request from the EV travel mode to the HV travel mode or to delay the generation thereof.

Accordingly, if it is rationally determined that the switching request from the EV travel mode to the HV travel mode will not be generated even when the operation mode is maintained to be the series mode, need for the operation mode control of the boosting converter 310 at least in view of warming of the catalyst is reduced.

Thus, in the operation mode control according to this embodiment, it is determined whether the drive shaft requested output Pdn will exceed a system maximum output value Wmaxs of the boosting converter 310 in the series mode in the immediate future (for example, during a period until the catalyst warm-up control is terminated with no trouble).

In other words, if it is determined in step S150 that the output shortage will occur (step S150: YES), the ECU 100 controls the operation mode of the boosting converter 310 to the parallel mode (step S120). On the other hand, if it is determined that the output shortage will not occur (step S150: NO), the ECU 100 selects the operation mode that corresponds to the driving condition of the hybrid vehicle 1 (step S130).

Here, various modes are available for the determination operation according to step S150. For example, the driving state of the vehicle in the immediate future can be determined by a car navigation system, a road-to-vehicle communication system, and the like. In such a case, if it is determined that the requested output of the drive shaft will not be changed substantially, a determination that the first operation mode can be continued can be established. In addition, when a change in the requested output of the drive shaft in the immediate past in the vehicle is converged in a specified range, a determination that the first operation mode can be continued can be established. Alternatively, if it is estimated that the catalyst warm-up control is terminated before the output shortage, which is caused by continuation of the first operation mode, becomes apparent by being recognized by a driver or the like, the determination that the first operation mode can be continued can be established. More specifically, when any of various known car navigation systems is equipped in the hybrid vehicle 1, a temporal transition of the drive shaft requested output Pdn can be estimated from a position of the host vehicle identified by a positioning system such as a GPS and surrounding landscape around the host vehicle (for example, a gradient of a road surface and the like) or a shape of a road around the host vehicle and the like. Since the system maximum output value Wmaxs has already been known from the output limit values of the first power supply B1 and the second power supply B2 at the time, it is possible by comparing both of the output limit values to determine whether the output shortage will occur with a certain level of reliability.

Alternatively, in a simpler manner, it can also be determined whether the output shortage will occur on the basis of the temporal transition of the drive shaft requested output Pdn in the immediate past of the hybrid vehicle 1. For example, when the drive shaft requested output Pdn hardly changed in the immediate past, the hybrid vehicle 1 is in a so-called steady traveling state. Accordingly, a determination that the drive shaft requested output Pdn will not be changed substantially in the immediate future can be established.

Further alternatively, it can also be determined whether the output shortage will occur on the basis of progress of the catalyst warm-up control. In other words, the catalyst warm-up control is the control executed in the finite time region for a purpose of warming the catalytic device 217 in an early stage. If the intake air amount, the fuel injection amount, the delayed amount of the ignition timing are already known, it is possible to estimate the amount of heat that is supplied to the catalytic device 217 per unit time during the execution period of the catalyst warm-up control. Thus, if the amount of heat that is required to warm the catalyst is found out experimentally, experientially, or theoretically in advance, a remaining time until the completion of the catalyst warm-up control can be found out. If this remaining time is short, the possible occurrence of the output shortage during the catalyst warm-up control is low. In addition, if this remaining time is short, and the output shortage temporarily occurs, the catalyst warm-up control is terminated before the driver actually feels the output shortage. Thus, the travel mode of the hybrid vehicle 1 can be shifted to the HV travel mode without causing the deterioration of the emissions. Noted that, in this case, the amount of heat that is supplied to the catalytic device 217 during the catalyst warm-up control need not necessarily be estimated. As a further simple method, the progress of the catalyst warm-up control may be determined simply by an execution time of the catalyst warm-up control.

While these methods constitute a mere example, it is possible to objectively determine whether the output shortage will occur in the execution period of the catalyst warm-up control at least on the basis of various known algorithms. Therefore, for example, “a specified condition” may set as “whether the whether the output shortage of the boosting converter 310 will occur in the execution period of the catalyst warm-up control”.

According to this embodiment, the series mode can be selected as the operation mode of the boosting converter 310 even during the catalyst warm-up control. In other words, the operation mode of the boosting converter 310 can be managed further flexibly by following the driving condition of the hybrid vehicle 1.

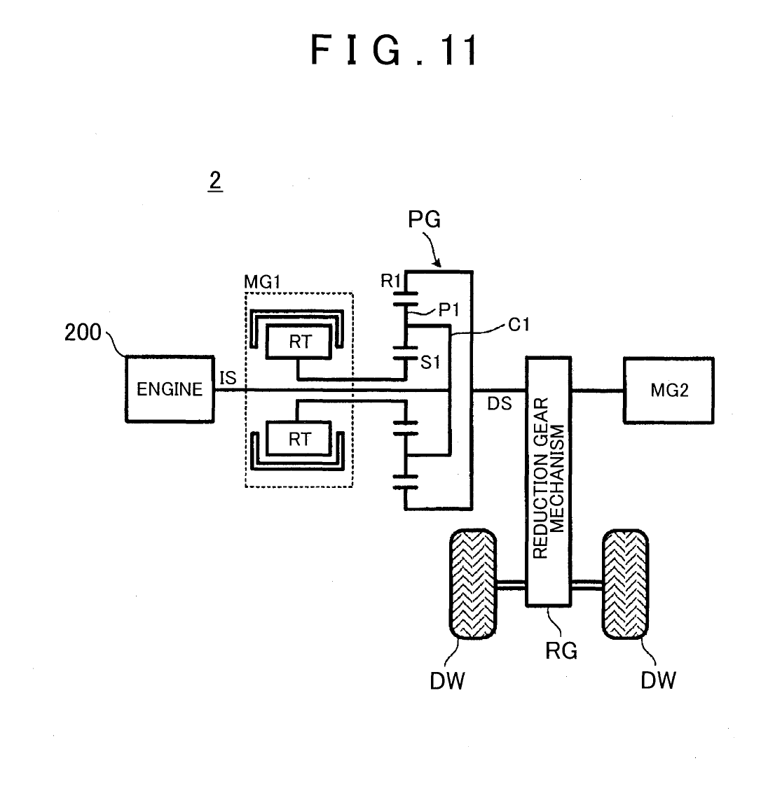

Noted that the hybrid vehicle 1 according to the first to third embodiments is a so-called hybrid vehicle of one motor type. However, the controller for the power converter according to the present invention can be applied to any vehicle regardless of a configuration thereof as long as the vehicle is a hybrid vehicle that includes an engine and a motor. For example, the controller for the power converter according to the present invention can also be applied to a hybrid vehicle 2 according to a fourth embodiment of the present invention that is exemplified in FIG. 11. Here, FIG. 11 is a schematic configuration diagram for schematically showing a configuration of a drive system of the hybrid vehicle 2. Noted that, in this drawing, portions that overlap with those in FIG. 1 are denoted by the same reference numerals and descriptions thereof will appropriately be omitted.

In FIG. 11, the hybrid vehicle 2 is an example of the “vehicle” according to the present invention that includes the engine 200, a motor generator MG1, a motor generator MG2, a power dividing mechanism PG, and the reduction gear mechanism RG.

The motor generator MG1 is a three-phase AC motor generator as an example of the “motor” according to the present invention, and has the power generation function for converting electrical energy to kinetic energy and the regeneration function for converting kinetic energy to electrical energy.

The motor generator MG2 is a three-phase AC motor generator as another example of the “motor” according to the present invention, and has the power generation function for converting electrical energy to kinetic energy and the regeneration function for converting kinetic energy to electrical energy like the motor generator MG1.

The power dividing mechanism PG is a planetary gear mechanism with two rotational degrees of freedom, the power dividing mechanism PG including: a sun gear S1 that is provided at the center; a ring gear R1 that is concentrically provided on an outer periphery of the sun gear S1; a plurality of pinion gears P1 that is arranged between the sun gear S1 and the ring gear R1 and each of which revolves around the outer periphery of the sun gear S1 while rotating; and a carrier C1 that supports rotational axis of each of these pinion gears.

In the power dividing mechanism PG, the sun gear S1 is coupled to an output rotational shaft of the motor generator MG1, and a rotational speed thereof is equivalent to MG1 rotational speed Nmg1 as a rotational speed of the motor generator MG1. In addition, the ring gear R1 is fixed to the drive shaft DS of the power dividing mechanism PG, and a rotational speed thereof is equivalent to the output rotational speed Nout as the rotational speed of the drive shaft DS. Furthermore, the carrier C1 is coupled to the input shaft IS of the power dividing mechanism PG, which is coupled to the crankshaft 204 of the engine 200, and a rotational speed thereof is equivalent to an engine speed Ne of the engine 200.

An output rotational shaft of the motor generator MG2 is coupled to the drive shaft DS, and the above-described output rotational speed Nout is equal to an MG2 rotational speed Nmg2 as a rotational speed of the motor generator MG2.

Although not shown, the motor generators MG1 and MG2 are driven by inverters that are provided to respectively correspond thereto. These plural inverters are an example of the “load” according to the present invention. The controller for the power converter according to the present invention can favorably be actuated for such a hybrid vehicle of so-called two-motor type.

Lastly, the controller for the power converter according to the present invention is applied to the power converter that has the series mode and the parallel mode as the operation modes. However, a problem to be solved by the present invention is attributed to fundamental portions of the series mode and the parallel mode, but is not attributed to an electrical connection method of the switching elements in the power converter. Thus, in what kind of a physical configuration the series mode and the parallel mode are realized has no correlation with advantages of the controller for the power converter according to the present invention. In other words, the controller for the power converter according to the present invention is not limited to the configuration of the boosting converter 310 that is exemplified in each of the above embodiments, but can be applied for controlling various types of the power converter, each of which has the series mode and the parallel mode as the operation modes.

The present invention is not limited to the above-described embodiments, and can appropriately be modified within the gist or thought of the invention which can be understood from the claims and the entire specification, and the controller for the power converter involving such a modification is also included in the technical scope of the present invention.

What is claimed is:

1. A controller for a power converter of a vehicle, the vehicle having an internal combustion engine, a motor, a first DC power supply and a second DC power supply, the internal combustion engine including a catalytic device, the power converter having a first operation mode and a second operation mode that define power supply modes of the first and second DC power supplies for a load, the first operation mode being an operation mode set when the first DC power supply and the second DC power supply are electrically connected in series to an electric wire, and the second operation mode being an operation mode set when the first DC power supply and the second DC power supply are electrically connected in parallel to the electric wire, the electric wire being electrically connected to the load, and the controller comprising:
an electronic control unit configured to:
execute warm-up promotion control of the catalytic device; and
set the operation mode of the power converter to the second operation mode when executing the warm-up promotion control.

2. The controller according to claim 1, wherein
the electronic control unit is configured to determine whether the warm-up promotion control is executed, and
the electronic control unit is configured to set the operation mode to the second operation mode when the electronic control unit determines that the warm-up promotion control is executed.

3. The controller according to claim 1, wherein
the electronic control unit is configured to prohibit setting of the operation mode to the first operation mode during execution of the warm-up promotion control.

4. The controller according to according to claim 1, wherein
the electronic control unit is configured to switch the operation mode in accordance with a driving condition of the vehicle when all of following conditions i) to iii) are satisfied,
i) when the warm-up promotion control is executed,
ii) when the first operation mode is selected as a previous operation mode, and
iii) when a specified condition is established except for a condition related to presence or absence of the execution of the warm-up promotion control.

5. A control method for a power converter of a vehicle, the vehicle including an internal combustion engine, a motor, a first DC power supply, a second DC power supply, the power converter and an electronic control unit, the internal combustion engine including a catalytic device, the power converter having a first operation mode and a second operation mode for defining power supply modes of the first and second DC power supplies to a load, the first operation mode being an operation mode set when the first DC power supply and the second DC power supply are electrically connected in series to an electric wire, and the second operation mode being an operation mode set when the first DC power supply and the second DC power supply are electrically connected in parallel to the electric wire, the electric wire being electrically connected to the load, and the control method comprising:
executing, by the electronic control unit, warm-up promotion control of the catalytic device; and
setting, by the electronic control unit, the power converter to the second operation mode when the warm-up promotion control is executed by the electronic control unit.
